(19) United States
(12) Patent Application Publication
(10) Pub. No.: US 2015/0192811 A1
(43) Pub. Date: Jul. 9, 2015

(54) DISPLAY DEVICE

(71) Applicant: Japan Display Inc., Tokyo (JP)

(72) Inventors: Tetsuya KOJIMA, Tokyo (JP); Toshiyuki HIGANO, Tokyo (JP)

(21) Appl. No.: 14/585,735

(22) Filed: Dec. 30, 2014

(30) Foreign Application Priority Data
Jan. 7, 2014 (JP) 2014-000675

(51) Int. Cl. G02F 1/1339; G02F 1/1341; G02F 1/1333

(52) U.S. Cl. CPC G02F 1/1339; G02F 1/13394; G02F 1/133377; G02F 1/1341; G02F 2001/13415

(57) ABSTRACT

A display device includes a first substrate, a second substrate, liquid crystal interposed between the first substrate and the second substrate, a sealing material formed in a closed pattern surrounding the liquid crystal in order to attach together the first substrate and the second substrate, and a barrier arranged along the pattern of the sealing material outside the sealing material to fill a gap between the first substrate and the second substrate.

### CLAIM OF PRIORITY

The present application claims priority from Japanese patent application JP2014-000675 filed on Jan. 7, 2014, the content of which is hereby incorporated by reference into this application.

### BACKGROUND

This disclosure relates to a display device and it is applicable to, for example, a display device which injects liquid crystal in a drop injection method.

In manufacturing a liquid crystal display panel, either a vacuum injection system or a drop injection (ODF: One Drop Filling) system is generally used as a method for injecting liquid crystal between two sheets of substrates forming the liquid crystal display panel.

In the ODF system, a sealing material is applied to an outer periphery of one substrate, the liquid crystal is dropped in the inner area of the substrate, and the other substrate is attached there in vacuum; thus, a liquid crystal display panel is assembled. The assembled liquid crystal display panel is thereafter released in atmosphere. As disclosed in Japanese Patent Publication No. 2013-3305, in order to even a gap between the substrates and prevent corrosion into seal (unnecessary corrosion of liquid crystal into the sealing material when the sealing material is not hardened yet), a column spacer is arranged in a sealing area or inside the sealing area adjacently, in a liquid crystal display panel manufactured in the ODF system.

### SUMMARY

The inventor has found the following problem in the manufacturing process of a liquid crystal panel according to the ODF system.

Specifically, a sealing material is formed, liquid crystal is dropped, and the substrates are attached together; however, in the release into atmosphere after the attachment, there occurs a difference in pressure between the inside of a liquid crystal cell (negative pressure) and the outside of a liquid crystal cell (ordinary pressure) with the sealing material not being hardened yet intervening therebetween, the corrosion into seal happens from the outside of the cell to the inside thereof in a opposite direction to that in the Japanese Patent Publication No. 2013-3305, and there is a fear of bubbling defect occurring caused by seal path, which causes a reduction in yield.

Other objects and new characteristics will be apparent from the description and attached drawings of this disclosure.

Of this disclosure, typical outline will be briefly described as follows.

Specifically, a display device includes a first substrate, a second substrate, liquid crystal interposed between the first substrate and the second substrate, a sealing material formed in a closed pattern surrounding the liquid crystal in order to attach together the first substrate and the second substrate, and a barrier arranged along the pattern of the sealing material outside the sealing material to fill a gap between the first substrate and the second substrate.

### BRIEF DESCRIPTION OF THE DRAWINGS

FIG. 1 is a view for use in describing a problem in the ODF method.

FIG. 2A is a top plan view of a first substrate and a second substrate before the attachment according to an embodiment.

FIG. 2B is a top plan view of a display panel after the attachment according to the embodiment.

FIG. 2C is a cross-sectional view taken along the line A-A′ of FIG. 2B.

FIG. 3 is a top plan view of a display device according to the embodiment.

FIG. 4 is an enlarged top plan view enlarging one pixel region.

FIG. 5 is a cross-sectional view of an important portion taken along the line C-C′ of FIG. 4.

FIG. 6A is an enlarged top plan view enlarging the portion B of FIG. 3 without illustrating a counter substrate.

FIG. 6B is a cross-sectional view taken along the line D-D′ of FIG. 6A.

FIG. 7A is a top plan view of a mother glass substrate with many cells arranged.

FIG. 7B is an enlarged top plan view of FIG. 7A.

### DESCRIPTION OF THE PREFERRED EMBODIMENTS

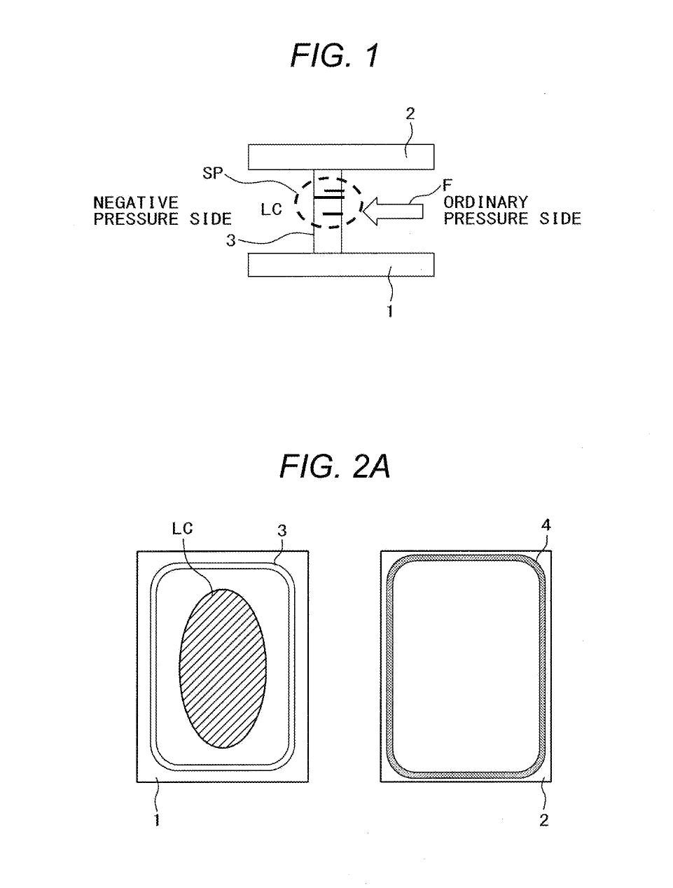

At first, the problems found by the inventor in the ODF method will be described with reference to FIG. 1.

FIG. 1 is a view for use in describing the problem in the ODF method.

In the ODF method, a pattern of a sealing material 3 for sealing liquid crystal LC is formed on one of two facing substrates and a proper amount of the liquid crystal LC is dropped. The whole body with a first substrate 1 and a second substrate 2 facing each other is decompressed, and the first substrate 1 and the second substrate 2 are attached to each other and released into atmosphere. Then, passing through the process of hardening the sealing material 3, the assembly is completed. Just after the attachment, since the sealing material 3 is not hardened yet, it is in an easy deformable state due to an external force. Further, just after the attachment, the inside of the sealing material 3 is in a decompressed state; on the other hand, the outside of the sealing material 3 is in an ordinary pressure. Therefore, as illustrated in FIG. 1, before passing through the sealing material hardening process, a force F causing a seal path works on the sealing material 3 not hardened, according to a pressure difference between the inside and outside of the sealing material 3, and as illustrated by an ellipse portion SP of dotted line, there is a fear of generating the corrosion into seal, and as a result, a failure in air bubbles happens, causing a reduction in the yield.

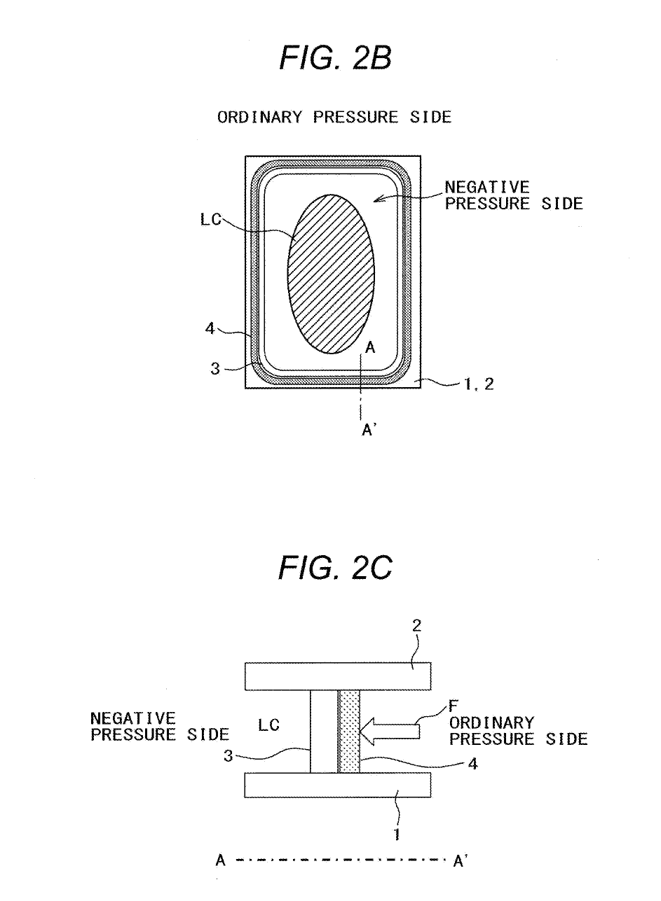

One embodiment will be described with reference to FIGS. 2A to 2C.

FIG. 2A is a top plan view of the first substrate and the second substrate before the attachment according to the embodiment. FIG. 2B is a top plan view of a display panel after the attachment according to the embodiment. FIG. 2C is a cross-sectional view taken along the line A-A′ of FIG. 2B.

As illustrated in FIG. 2A, a pattern of the sealing material 3 for sealing liquid crystal LC is formed in the first substrate 1 and a proper amount of the liquid crystal LC is dropped there. In the second substrate 2, a barrier 4 is formed in a ring shape along the pattern of the sealing material 3 so that the barrier may be positioned outside the sealing material 3. As illustrated in FIG. 2B, the whole body with the first substrate 1 and the second substrate 2 facing each other is decompressed, and the first substrate 1 and the second substrate 2 are attached to each other and released into atmosphere. Then, passing through the process of hardening the sealing material 3, the assembly is completed.

As illustrated in FIG. 2C, a force F working on the sealing material 3 not hardened just after the ODF assembly from the outside (ordinary pressure side) to the inside (negative pressure side) due to a pressure difference can be physically prevented by the barrier 4. In other words, by patterning the barrier 4 in contact with the pattern of the sealing material 3, when the first substrate 1 and the second substrate 2 are attached together, the sealing material 3 not hardened is not directly subject to the external force F due to a pressure difference; as a result, the corrosion into seal can be suppressed.

It is preferable that the height of the pattern of the barrier 4 should be possibly equal to a space between the first substrate 1 and the second substrate 2 in order to protect the sealing material 3 from an external pressure. Supposing that the first substrate is an array substrate (TFT substrate) and the second substrate is a counter substrate (CF substrate), since it is considered that there are a metal ranging through many layers and a step caused by an insulating film in the TFT substrate, the sum of (the step in the first substrate) +(the height of the barrier) is preferably set equal to a desired distance between the substrates, considering the height of the formed position of the barrier 4.

Hereinafter, the embodiment of the invention will be described with reference to the drawings. The embodiment described below is to illustrate a liquid crystal display device for embodying the technical sprit of the invention; the invention is not intended to specify this liquid crystal display device but can be properly applied to other embodiments included in the scope of the claims. In the drawings used for describing this specification, each layer and each component are indicated large enough to be recognized in the drawings; therefore, the ratio of size in each layer and each component is displayed differently from the actual measurement.

A display device in the embodiment can be applied to a liquid crystal display device of a so-called vertical field system which is driven in the TN (Twisted Nematic) mode, the VA (Vertical Alignment) mode or the MVA (Multi-domain Vertical Alignment) mode and a liquid crystal display device of a transverse field system in the IPS (In-Plane Switching) mode and the FFS (Fringe Field Switching) mode; for all that, the display device of the embodiment will be described below as represented by the liquid crystal display device in the TN mode.

### EMBODIMENT

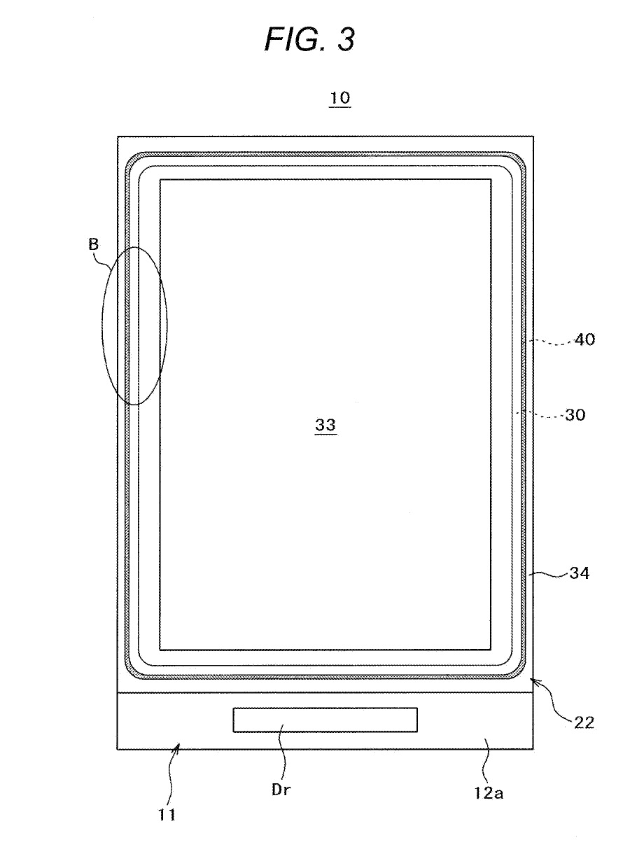

A display device according to the embodiment will be described with reference to FIGS. 3 to 6B.

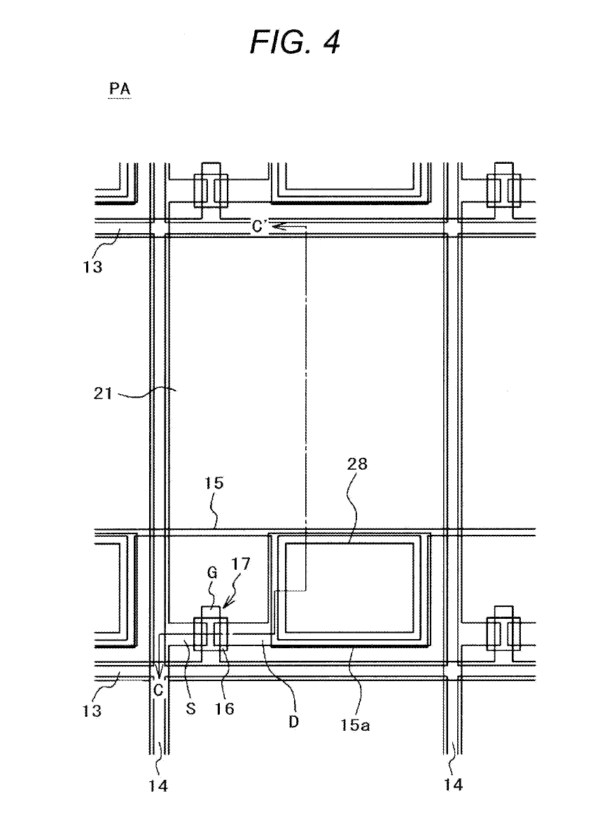

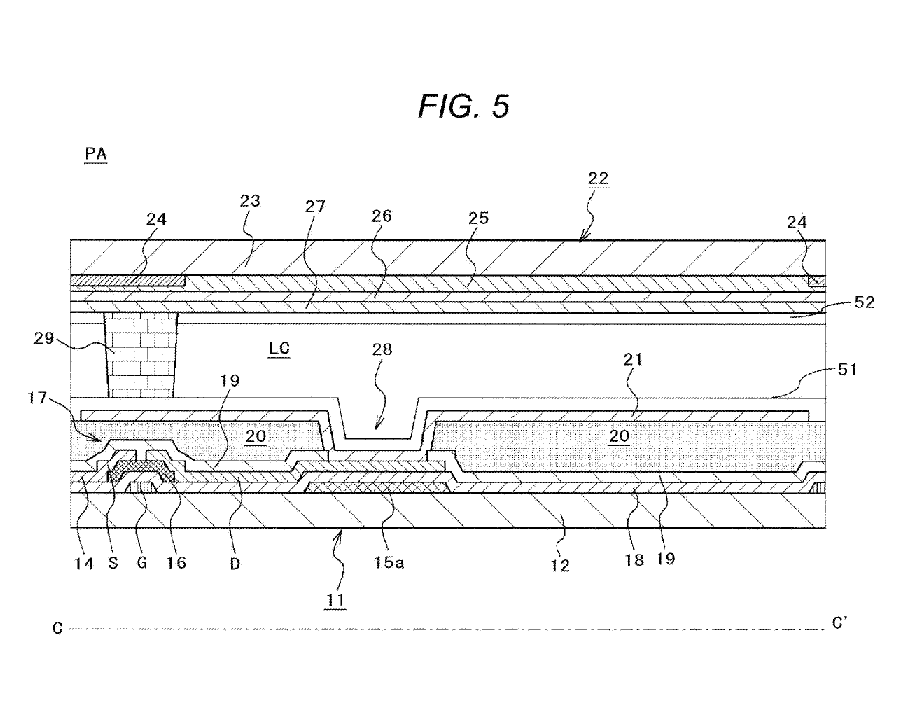

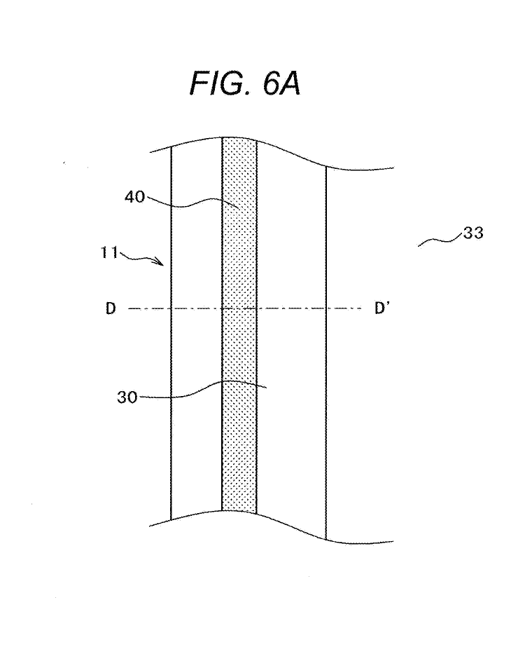

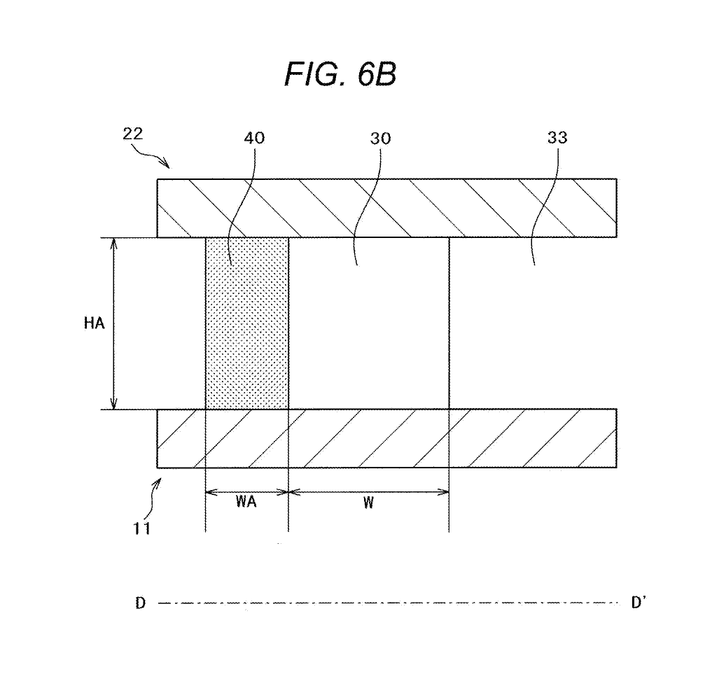

FIG. 3 is a top plan view of a display device according to the embodiment. FIG. 4 is an enlarged top plan view enlarging one pixel area. FIG. 5 is a cross-sectional view of an important portion taken along the line C-C′ of FIG. 4. FIG. 6A is an enlarged top plan view enlarging the portion B of FIG. 3 without illustrating a counter substrate. FIG. 6B is a cross-sectional view taken along the line D-D′ of FIG. 6A.

As illustrated in FIGS. 3 and 5, a display device 10 according to the embodiment includes an array substrate (first substrate) 11, a counter substrate (second substrate) 22, a sealing material 30 for attaching together the array substrate 11 and the counter substrate 22, and liquid crystal LC sealed in an area surrounded by the array substrate 11, the counter substrate 22, and the sealing material 30. In the liquid crystal display device 10, the area surrounded by the sealing material 30 forms a display area 33, and the outer peripheral side of the display area 33 becomes a frame area 34 including the application area of the sealing material 30. Further, since the display device 10 is manufactured according to the ODF method, an inlet of the liquid crystal is not formed.

As illustrated in FIGS. 3 to 6B, the array substrate 11 includes various kinds of wirings for driving the liquid crystal formed on the surface of the transparent substrate 12 made of a rectangular glass substrate. The array substrate 11 is longer than the counter substrate 22 oppositely arranged, in the longitudinal direction, and when the array substrate 11 and the counter substrate 22 are attached to each other, an extending portion 12a extending externally is formed. A driver Dr formed of IC chip or LSI to supply a signal for driving the liquid crystal is mounted in the extending portion 12a in a COG (Chip On Glass) system.

As illustrated in FIGS. 4 and 5, within the display area 33 of the array substrate 11, a plurality of scanning lines 13 and signal lines 14 are formed in a matrix shape and the plural scanning lines 13 and signal lines 14 are extended and drawn to the outside of the display area 33 and connected to the driver Dr. Further, within the display area 33 of the array substrate 11, a plurality of auxiliary capacitance lines 15 are respectively provided between the scanning lines 13, in parallel to the scanning lines 13, and a gate insulating film 18 is provided to cover each scanning line 13, auxiliary capacitance line 15, auxiliary capacitance electrode 15a, and the exposed transparent substrate 12. On the surface of the gate insulating film 18, a semiconductor layer 16 is formed in the vicinity of the intersection of the scanning line 13 and the signal line 14, and further the signal line 14 and a source electrode S connected to the signal line 14 and a drain electrode D are formed. A part of the source electrode S and the drain electrode D overlaps with the semiconductor layer 16 in a plane view, and a thin film transistor (TFT: Thin Film Transistor) 17 is formed by the source electrode S, the gate electrode G, the drain electrode D, and the semiconductor layer 16 as a switching element.

A passivation film 19 made of inorganic insulating material is formed to cover the TFT 17, the signal line 14, and the exposed surface of the gate insulating film 18, and further an interlayer film 20 made of organic insulating material is formed in order to flatten the surface of the array substrate 11. A pixel electrode 21 made of, for example, ITO (Indium Tin Oxide) or IZO (Indium Zinc Oxide) is provided in every one pixel area PA surrounded by the scanning lines 13 and the signal lines 14 on the surface of the interlayer film 20, and a contact hole 28 for electrically connecting the drain electrode D is provided. An alignment film 51 is provided on the surface thereof and the rubbing processing or the photo-alignment processing is performed on the alignment film 51, hence to form the array substrate 11.

The counter substrate 22 includes a light shielding film 24 to cover the position corresponding to the scanning line 13, the signal line 14, the contact hole 28, and the TFT 17 of the array substrate 11, on the surface of a second transparent substrate 23 made of a glass substrate, as illustrated in FIG. 5. Further, a color filter layer 25 of a predetermined color, for example, red (R), green (G), or blue (B) is formed in every sub-pixel on the surface of the second transparent substrate 23 surrounded by the light shielding film 24. Further, an overcoat layer 26 is formed to cover the surface of the light shielding film 24 and the color filter layer 25. The overcoat layer 26 is made of an insulating transparent resin film and provided in order to flatten the surface of the counter substrate 22 as plane as possible and not to elute the dopant from the color filter layer 25 to the liquid crystal LC.

Then, a common electrode 27 made of, for example, ITO or IZO is provided to cover the overcoat layer 26. Further, a column-shaped photospacer (column spacer) 29 is provided in order to keep a cell gap between the substrates at a constant level. An alignment film 52 is provided on the surface of the common electrode 27, and the rubbing processing or the photo-alignment processing is performed on the alignment film 52, hence to form a color filter substrate 22. In the display device 10, a photospacer 40 that is a barrier described later is formed in the counter substrate 22 in a ring shape (wall surface shape) at a position in contact with the outside of the sealing material 30.

Then, for example, after the sealing material 30 is applied to the surface of the array substrate 11 in a closed loop shape, the liquid crystal LC is injected according to the ODF method, the counter substrate 22 is overlapped there, and the sealing material 30 is hardened by radiation of ultraviolet ray, hence to attach together the array substrate 11 and the counter substrate 22.

The photospacer 40 is formed in a ring shape along the sealing material 30 at the outside position of the sealing material 30 in a plane view, as illustrated in FIG. 3. In short, the photospacer 40 is formed in a closed pattern. The photospacer 40 is formed in a straight line in the place where the sealing material 30 is in the straight line pattern. The width WA of the photospacer 40 is narrower than the width W of the sealing material 30, as illustrated in FIGS. 6A and 6B. The height HA of the photospacer 40 is made equal to the distance between the both substrates. The photospacer 40 is formed of the same material as the column spacer 29, and therefore, the photospacer 40 can be formed in the same process together with the column spacer 29. Therefore, it does not need to add any special material and to increase any new process to form the barrier. The photospacer 40 is preferably in contact with the sealing material 30; however, there may be a space between the photospacer 40 and the sealing material 30.

Then, when scribing is carried out and a driver is set in the extending portion 12a of the array substrate 11, the display device 10 is completed.

As mentioned above, according to the display device 10 of the embodiment, a barrier is previously formed at the position outside of the sealing material in a plane view, in a display device manufactured according to the ODF method, hence to obtain a highly-reliable display device which can suppress corrosion into seal. By forming the barrier outside the sealing material, the barrier is arranged further distant from the display area than in the case of forming the barrier inside the sealing material; as a result, it is possible to reduce the effect of a gap irregularity on the occasion of a fear of generating the gap irregularity in the periphery when a variation of the height occurs in the formed barrier. In short, the sealing material portion can relax the gap variation.

In the embodiment, the pattern of the photospacer 40 is a closed loop pattern, and in the corner portion, there may arise a problem that a cell gap accuracy in the periphery cannot be secured at ease because many base patterns traverse the corner portion. In this occasion, a means of not forming the photospacer 40 only in the corner portion can be taken inevitably. In this case, although a corrosion prevention effect of the sealing material 30 cannot be obtained in the corner portion, the corrosion prevention effect can be obtained without problem in the straight line portion of the sealing material 30, and some improvement in the yield can be obtained although it is deteriorated in the yield compared with in the case of the closed pattern.

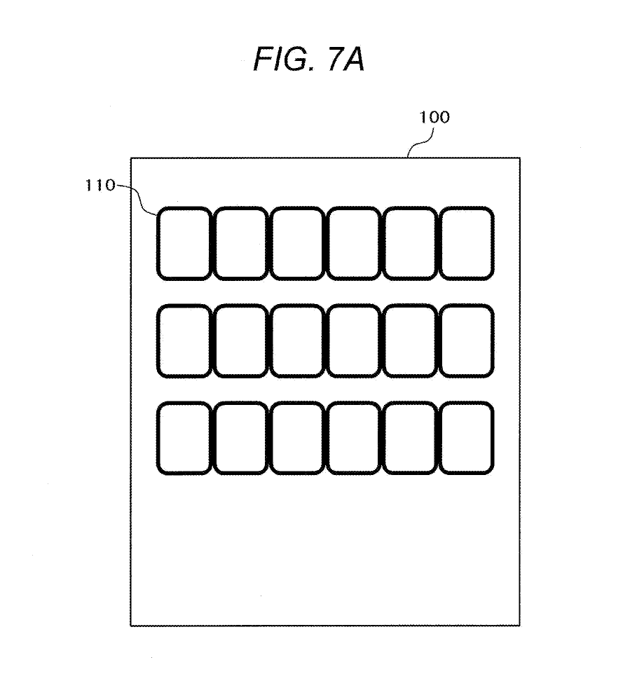

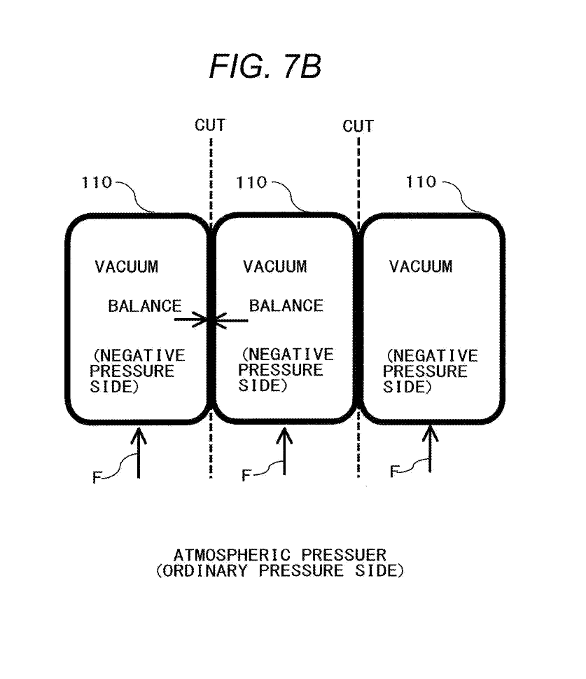

The case of arranging a plurality of cells in the mother glass substrate will be described with reference to FIGS. 7A and 7B.

FIG. 7A is a top plan view of a mother glass substrate with many cells arranged. FIG. 7B is an enlarged top plan view of FIG. 7A.

As illustrated in FIG. 7A, when many cells 110 are arranged in the mother glass substrate 100, a design in which a cut line of the cells 110 adjacent to each other in the horizontal direction is shared, is often used to save the waste of glass. In this case, there is no fear of generating the above corrosion in the horizontal direction (a direction vertical to the direction of the shared cut line). This is why the sealing materials of the adjacent cells are in contact with each other and there occurs no pressure difference, as illustrated in FIG. 7B. Therefore, in this design, it is not always necessary to provide the photospacer 40 that is the barrier in the horizontal direction but if only providing the photospacer 40 just only in the vertical direction, a sufficient effect can be obtained.

What is claimed is:

1. A display device comprising:
a first substrate;
a second substrate;
liquid crystal interposed between the first substrate and the second substrate;
a sealing material formed in a closed pattern surrounding the liquid crystal in order to attach together the first substrate and the second substrate; and
a barrier arranged along the pattern of the sealing material outside the sealing material to fill a gap between the first substrate and the second substrate.

2. The device according to claim 1, wherein the barrier is arranged in a ring shape along the pattern of the sealing material.

3. The device according to claim 1, wherein the barrier is a photospacer of a wall surface shape formed in the second substrate in a closed pattern along the outside of the sealing material.

4. The device according to claim 1, wherein the barrier is arranged in a straight line direction of the pattern of the sealing material.

5. The device according to claim 1, wherein the barrier is a photospacer of a wall surface shape formed in the second substrate in a straight line pattern along the outside of the sealing material.

6. The device according to claim 1, wherein the barrier is arranged in a direction crossing a cut line shared between adjacent cells.

7. The device according to claim 1, wherein the barrier is a photospacer of a wall surface shape formed in the second substrate in a direction crossing a cut line shared between adjacent cells.

8. The device according to claim 1,
wherein the first substrate is an array substrate, and
the second substrate is a counter substrate.

9. The device according to claim 1, further comprising column spacers scattered in an area surrounded by the sealing material to keep a gap between the first substrate and the second substrate in the area surrounded by the sealing material at a predetermined distance.

10. The device according to claim 1,
wherein the first substrate includes a pixel electrode, and
the second substrate includes a counter electrode.
